(19) United States
(12) Patent Application Publication
(10) Pub. No.: US 2004/0193717 A1
(43) Pub. Date: Sep. 30, 2004

(54) Service processing apparatus and service processing method

(75) Inventors: Yukio Tajima, Ebina-shi (JP); Yuji Hikawa, Ebina-shi (JP); Kazuko Kirihara, Ebina-shi (JP); Akihiro Enomoto, Ebina-shi (JP); Hidekazu Ozawa, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 10/662,334

(22) Filed: Sep. 16, 2003

(30) Foreign Application Priority Data
Mar. 24, 2003 (JP) 2003-079270

(51) Int. Cl. G06F 15/16

(52) U.S. Cl. 709/228; 719/318

(57) ABSTRACT

A service processing apparatus and a service processing method make devices connected to a network cooperatively effect plural processes on document data when a specific event occurs. When a user defines a processing timing so that a job is executed when the specific event occurs in a desired job flow and a predetermined device, an instruction generating server creates an instruction and sends it to an instruction managing server together with a processing timing information. When the instruction managing server has been notified that the specific event has occurred, the instruction managing server identifies the instruction from the correspondence relation between the instruction and the processing timing and sends the instruction to a cooperate processing server. The cooperative processing server requests the devices to conduct processing so that a document is processed in accordance with the content of the instruction, and makes the devices cooperatively effect plural processes.

### BACKGROUND OF THE INVENTION

1. Field of the Invention

The present invention relates to a service processing apparatus and a service processing method, and in particular to a service processing apparatus and a service processing method that are suited for use in a workflow system that converts paper documents to electronic files to construct a workflow.

2. Description of the Related Art

Conventionally, multifunction systems that combine the functions of a facsimile, a scanner and a printer have been proposed for copying machines. Thus, paper office work using copying machines and facsimiles and the processing of electronically converted documents on a personal computer can be cooperated.

Specifically, paper documents can be scanned and transferred to a personal computer, and documents received by facsimile can be sent to a personal computer as image data without being printed. Moreover, there is a demand to cooperate and automatize many procedures and processing after paper documents and documents received by facsimile have been converted to electronic files.

To this end, technologies have conventionally been proposed where job templates, in which desired settings are described in regard to items requiring setting in the composite machine, are prepared in advance, the job template is designated, and processing is conducted after the settings have been changed as needed.

For example, a conventional image forming device can plurally save output setting data (job templates) for setting output formats and can form and output images using an output format in accordance with the selected output setting data (e.g., see JP-A-10-83263, pp. 5-7 and FIGS. 2 and 5).

An image forming device where a box command is designated in a mailbox, so that the box command is executed at a timing at which documents have accumulated in the mailbox, is also known. According to this device, documents that have accumulated by fax reception in the mailbox can be delivered to an automatically designated delivery destination.

However, the image forming device described in JP-A-10-83263 uses only the “output format”, i.e., the function of the device itself, as the setting target. Thus, there has been the problem that the image forming device cannot effect cooperation of plural processes because it cannot conduct setting of other printers and scanners connected to a network and setting of cooperation of processing. The same is true of the image forming device that can designate the box command.

Also, the box command is executed only at a timing at which documents have entered the mailbox, and processing other than processing of documents that have accumulated in the mailbox cannot be conducted. Thus, there have been the problems that processing of documents cannot be conducted by other events, and a wide variety of processing cannot be conducted.

### SUMMARY OF THE INVENTION

The present invention has been devised in order to eliminate the aforementioned problems, and provides a service processing apparatus and a service processing method that can cause equipments connected to a network to cooperatively effect plural processes to be executed on document data when a specific event occurs.

According to an aspect of the invention, there is provided service processing apparatus comprising: a storing unit in which are stored (a) instruction data in which are described at least a location of processing document data and a content of plural service processes to be executed on the document data and (b) a correspondence relation between instruction data that is to be processed when a specific event occurs and the specific event; an identifying unit for identifying, when notification is given by at least one of plural service processing apparatuses each connected to a network that the specific event has occurred, instruction data corresponding to the notified specific event on the basis of the correspondence relation; an interpreting unit for interpreting the content of the identified instruction data; and a cooperative processing unit for causing the plural service processing apparatuses to cooperatively execute the plural service processes on the document data on the basis of the interpretation result of the interpreting unit.

According to another aspect of the invention, there is provided a service processing method comprising: an identifying step of identifying, when notification is given by at least one of plural service processing apparatuses each connected to a network that a specific event has occurred, instruction data that corresponds to the notified specific event and in which are described at least a location of processing document data and a content of plural service processes to be executed on the document data, on the basis of a correspondence relation between the specific event and instruction data that is to be processed when the specific event occurs; an interpreting step of interpreting the content of the identified instruction data; and a cooperative processing step of causing the plural service processing apparatuses to cooperatively execute the plural service processes on the document data on the basis of the interpretation result of the interpreting step.

According to yet another aspect of the invention, there is provided a service processing apparatus comprising: a storing unit in which are stored (a) instruction data in which are described at least a location of processing document data and a content of plural service processes to be executed on the document data and (b) a correspondence relation between instruction data that is to be processed when a specific event occurs and the specific event; an identifying unit for identifying, when notification is given by at least one of plural service processing apparatuses each connected to a network that the specific event has occurred, instruction data corresponding to the notified specific event on the basis of the correspondence relation; and a sending unit for sending, to a cooperative processing apparatus that cooperatively executes the plural service processes on the document data, the instruction data identified by the identifying unit.

According to still another aspect of the invention, there is provided a service processing method comprising: an identifying step of identifying, when notification is given by at least one of plural services processing apparatuses each connected to a network that a specific event has occurred, instruction data that corresponds to the notified specific event and in which are described at least a location of processing document data and a content of plural service processes to be executed on the document data, on the basis of a correspondence relation between the specific event and instruction data that is to be processed when the specific event occurs; a sending step for sending the identified instruction data to a cooperative processing apparatus that cooperatively executes the plural service processes on the document data.

According to yet another aspect of the invention, there is provided a service processing apparatus comprising: a storing unit in which are stored (a) instruction data in which are described at least a location of processing document data and a content of plural service processes to be executed on the document data and (b) a correspondence relation between instruction data that is to be processed when a specific event occurs and the specific event; an identifying unit for identifying, when notification is given by at least one of plural service processing apparatuses each connected to a network that the specific event has occurred, instruction data corresponding to the notified specific event on the basis of the correspondence relation; and a sending unit for sending, to another service processing apparatus that conducts service processes on the document data described in the instruction data, the instruction data identified by the identifying unit.

According to still another aspect of the invention, there is provided a service processing method comprising: an identifying step of identifying, when notification is given by at least one of plural services processing apparatuses each connected to a network that a specific event has occurred, instruction data that corresponds to the notified specific event and in which are described at least a location of processing document data and a content of plural service processes to be executed on the document data, on the basis of a correspondence relation between the specific event and instruction data that is to be processed when the specific event occurs; and a sending step for sending the identified instruction data to another service processing apparatus that conducts service processes on the document data described in the instruction data.

### BRIEF DESCRIPTION OF THE DRAWINGS

Preferred embodiments of the present invention will be described in detail based on the following figures, wherein:

FIG. 1 is a block diagram showing the configuration of a document processing system pertaining to a first embodiment of the invention;

FIG. 2 is a block diagram for describing the flow of information between sections of the document processing system;

FIG. 3 is a diagram showing the configuration of I/F information stored in devices;

FIG. 4 is a diagram showing an instruction editor screen displayed on a GUI of an instruction editor,

FIG. 5 is a diagram showing the configuration of an instruction created by an instruction creating unit;

FIG. 6 is a flow chart showing a sequence of instruction creation processing;

FIG. 7 is a flow chart showing a sequence of cooperative processing of the document processing system;

FIG. 8 is a diagram showing an example of an instruction list screen showing a list of instructions;

FIG. 9 is a diagram showing an instruction editor screen displayed on a GUI of an instruction editor;

FIG. 10 is a diagram showing an example of a file destination designation screen;

FIG. 11 is a diagram showing an example of a processing timing setting screen;

FIG. 12 is a functional block diagram of a composite machine; and

FIG. 13 is a block diagram for describing the flow of information between sections of a document processing system pertaining to a second embodiment of the invention.

### DETAILED DESCRIPTION OF THE PREFERRED EMBODIMENTS

Preferable embodiments of the invention will be described in detail below with reference to the drawings.

### First Embodiment

(System Configuration)

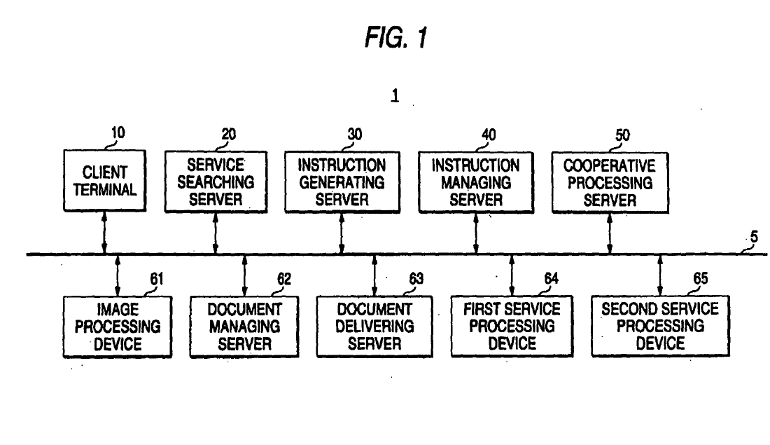

FIG. 1 is a block diagram showing the configuration of a document processing system 1 pertaining to a first embodiment of the invention.

The document processing system 1 is a system where applications and devices that conduct various services are connected via a network 5. Here, “services” refers to usable functions relating to documents in response to a demand from the outside. Examples of such services include copying, printing, scanning, sending/receiving facsimiles, mail delivering, storing in a repository and reading from a repository, OCR (Optical Character Recognition) processing and noise removal processing. However, the services are not particularly limited.

The document processing system 1 includes: a client terminal 10 disposed with a user interface for effecting cooperation of plural services and for instructing processing that a user desires; a service searching server 20 that searches for the services that the user desires; an instruction generating server 30 that creates an instruction from information relating to the service cooperation instructed by the client terminal 10; an instruction managing server 40 that manages the instruction; and a cooperative processing server 50 that executes cooperative processing of the respective services in accordance with the instruction.

The document processing system 1 also includes: an image processing device 61 that conducts image processing on an image document, such as noise removal processing, image rotation processing, OCR processing, and binding images; a document managing server 62 that manages documents; a document delivering server 63 that delivers documents; a first service processing device 64 that conducts first service processing; and a second service processing device 65 that conducts second service processing.

It should be noted that, although the document processing system 1 of the present embodiment has a configuration where plural servers conducting predetermined service processing are connected via the network 5, the document processing system 1 is not particularly limited as long as plural servers are connected via the network 5.

Here, “instruction” refers, in a case where a series of processing is divided into plural functional processes, to data including information representing relations of respective functions, interface (I/F) information for calling up respective functions, and information for configuring a graphical user interface (GUI) relating to the series of processing.

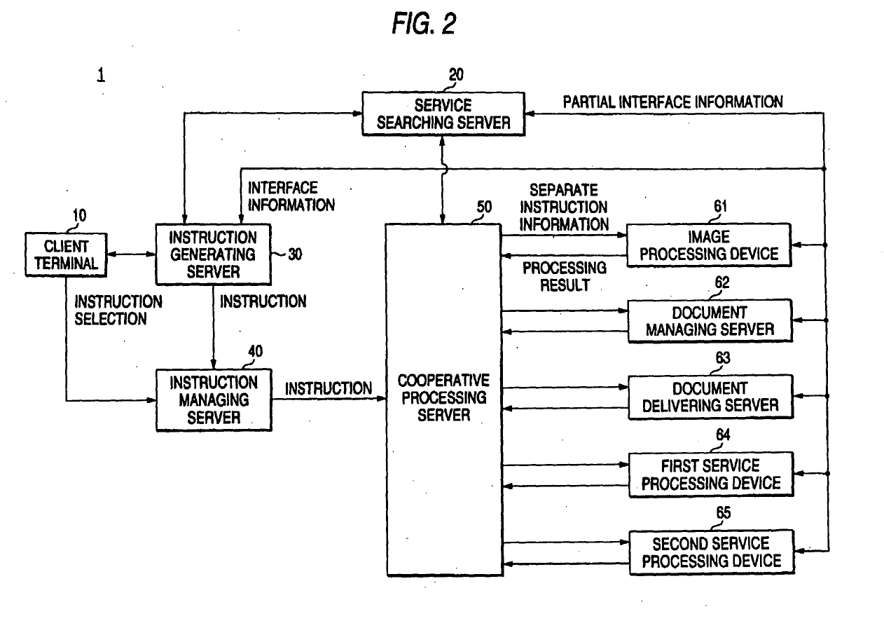

FIG. 2 is a block diagram for describing the interrelation of the service processing devices configuring the document processing system 1. The service processing devices store I/F information representing the content of the services that they themselves provide.

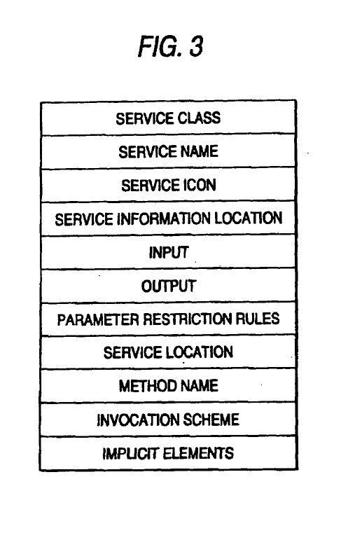

FIG. 3 is a diagram showing the configuration of the I/F information. The I/F information is configured by a “Service Class”, a “Service Name”, a “Service Icon”, a “Service Information Location”, an “Input”, an “Output”, “Parameter Restriction Rules”, a “Service Location”, a “Method Name”, an “Invocation Scheme” and “Implicit Elements”.

The “Service Class” is the class of service (processing content) that the service processing devices provide. It should be noted that a predefined service class is used for the “Service Class”, and examples thereof include scanning, printing, repositing and flowing. The “Service Name” is the name of the service that the service processing devices provide. The “Service Icon” is position information of icons displayed on the GUI of the client terminal 10.

The “Service Information Location” is the URL that the instruction generating server 30 uses in order to acquire the I/F information. The “Input” is the input of the service. The “Output” is the output of the service. The “Parameter Restriction Rules” are restriction rules applied to the “Input”. The “Service Location” is position information when the service is actually used In the “Method Name”, the method of providing the service processing and the name that refers to and represents the service are described. The “Invocation Scheme” is the scheme for calling up and invoking the service processing. It should be noted that SOAP (Simple Object Access Protocol) or SMTP (Simple Mail Transfer Protocol), which are protocols for message exchange, can be used for the “Invocation Scheme”. The “Implicit Elements” are not data explicitly sent as output to processing of a later stage, but are data that can be referenced at processing of a later stage.

The client terminal 10 is disposed with the function of a graphical user interface (GUI) for displaying screens and conducting predetermined operations in order to instruct the creation of an instruction or select an instruction that is to be invoked.

The service searching server 20 searches, from among plural services connected to the network 5, for services corresponding to search conditions. The service searching server 20 stores in advance a part of the I/F information (referred to below as “partial I/F information”) of various service processing devices such as the image processing device 61, the document managing server 62, the document delivering server 63, the first service processing device 64 and the second service processing device 65. Here, “partial I/F information” refers to the “Service Class”, the “Service Name”, the “Service Information Location”, the “Input” and the “Output” of the elements of the I/F information.

The service searching server 20 uses the partial I/F information of the service processing devices to search for services when search conditions are sent from the instruction generating server 30 or the cooperative processing server 50. For example, when the service searching server 20 searches for a service that is the same as a predetermined service, the service searching server 20 may search for a service whose “Service Class” matches that of the predetermined service, may search for a service whose “Input” and “Output” match those of the predetermined service, or may search for a service where all of these match those of the predetermined service.

The instruction generating server 30 acquires the I/F information from the service processing devices at the time the instruction is created, and generates an instruction for effecting cooperation of services that the service processing devices provide. The instruction generating server 30 specifically executes the following processing in order to create the instruction.

The instruction generating server 30 requests, on the basis of the “Service Information Location”, predetermined service processing devices distributed on the network S to send the I/F information relating to their services. When there is no predetermined service processing device, the instruction generating server 30 sends, with respect to the service searching server 20, an instruction to search for other service processing devices conducting the same service as that of the predetermined service processing devices. The instruction generating server 30 may acquire the “Service Information Location” of other service processing devices from the service searching server 20.

The instruction generating server 30 manages the search results from the service searching server 20 and the I/F information received from the service processing devices. The instruction generating server 30 generates, on the basis of the I/F information acquired from the service processing devices, an HTML file serving as a GUI screen for defining a job flow (cooperative processing). When there is a request from the client terminal 10 to browse the services, the instruction generating server 30 sends the HTML file serving as the GUI screen to the client terminal 10.

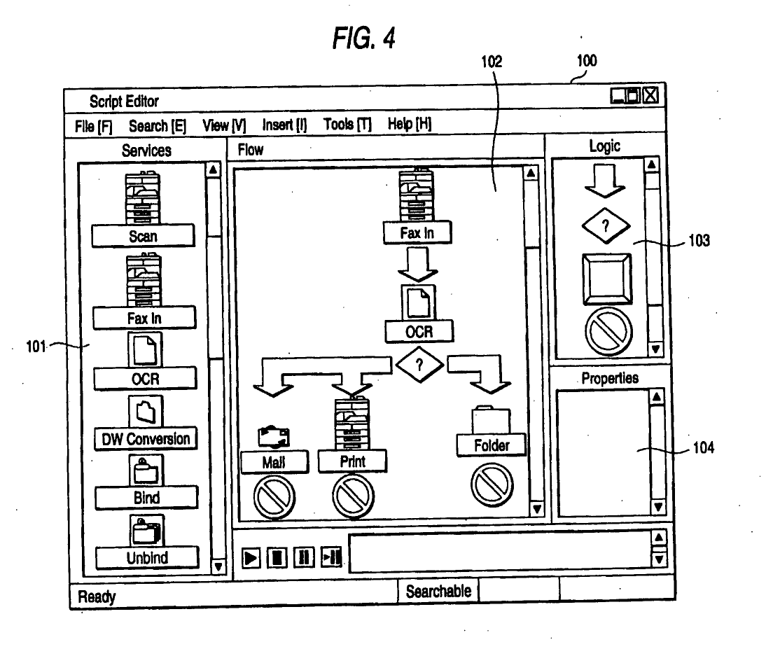

FIG. 4 is a diagram showing an instruction creation screen 100 that is a GUI screen for defining a job flow. The instruction creation screen 100 is configured by a service window 101, a flow window 102, a logic window 103 and a property window 104.

The service window 101 displays various usable service processing devices. The logic window 103 displays a job flow showing a pattern of cooperation between services. The property window 104 displays detailed setting parameters of icons displayed in the service window 101 and the logic window 103.

The user can define a job flow in the flow window 102 by dragging icons in the service window 101 and icons in the logic window 103 and dropping them in the flow window 102. The user can also set in detail relations between the services such as the services and the logic by editing the content displayed in the property window 104.

In this manner, the user drags icons in the service window 101 and icons in the logic window 103 and drops them in the flow window 102, defines a job flow and edits the content displayed in the property window 104, whereby the user can easily create an instruction for effecting cooperation of various and complicated processing.

The invention may also be configured so that it can conduct user authentication prior to the display of the instruction creation screen 100 or from the instruction creation screen 100. In this case, an unillustrated user authentication screen is displayed and the user is prompted to input a user ID and a password. The user authentication can be conducted by storing in advance, in the instruction managing server 40, a list of user IDs and passwords for which use of the system is allowed, and comparing this with the user ID and the password inputted in the user authentication screen. Thus, separate processing per user becomes possible.

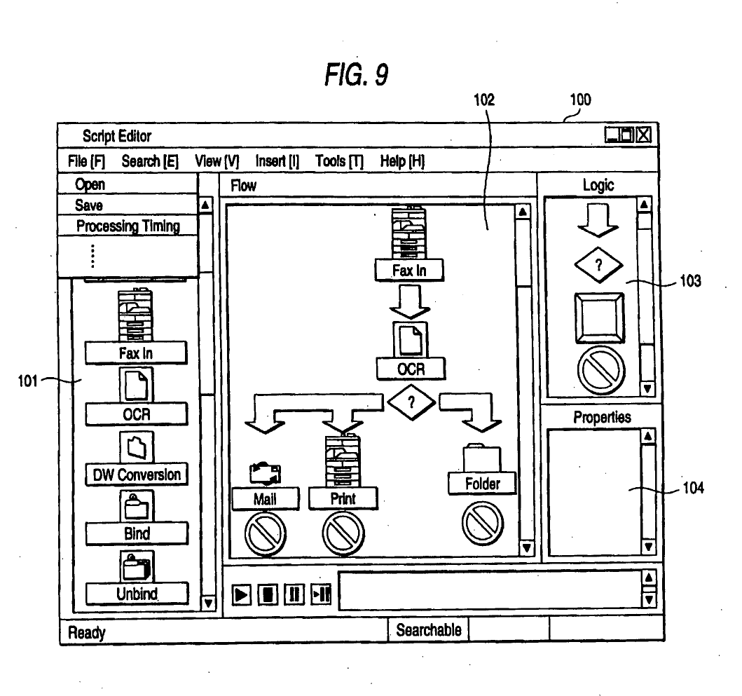

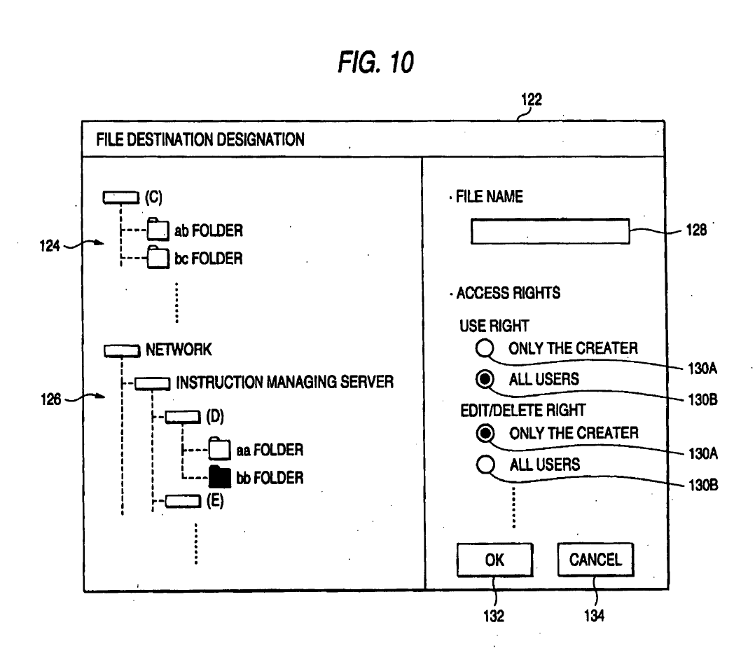

Also, the created instruction can be saved by designating a file destination. For example, in the instruction creation screen 100 of FIG. 4, when “File [F]”, which is a menu relating to file operations, is clicked, a pull-down menu 120 is displayed as shown in FIG. 9. When “Save” in the pull-down menu 120 is clicked, a file destination designation screen 122 such as shown in FIG. 10 is displayed.

In the file destination designation screen 122, a folder structure 124 of the client terminal 10 and a folder structure 126 of devices connected to the network 5, such as the instruction managing server 40, are displayed in a tree format. Also displayed are a box 128 for designating a file name for the instruction, boxes 130A and 130B for setting access rights relating to use allowance of the instruction, such as a use right necessary for using the instruction and an edit/delete right necessary for editing or deleting the instruction, an OK button 132 and a cancel button 134.

The user first references the file destination designation screen 122 and designates the folder of the file destination by clicking that folder. Here, the designated folder may be shaded as shown in FIG. 10 so that it can be easily confirmed. Then, the user inputs a desired file name in the box 128 for designating the file name, and conducts setting of the access rights.

Here, the access rights can be alternatively set so that they are given only to the creator of the instruction or so that they are commonly given to all users. Thus, the boxes 130A or 130B can be alternatively checked, and a black circle is displayed in the checked boxes to show which boxes have been checked. It should be noted that it is necessary for user authentication to be conducted when the access rights are given only to the creator of the instruction.

Also, although the access rights in the present embodiment include the use right and the edit/delete right, the invention is not limited thereto. Other access rights, such as the right to change the access rights or the like, may also be set. Also, although there are two types of targets to whom the access rights are given in the present embodiment, i.e., only the creator or all users, the invention is not limited thereto. Three or more types of targets to which the access rights are given may also be set so that, for example, a setting can be made to give the access rights only to specific groups of users.

When the OK button 132 is clicked after the file name is designated and the access rights have been set in this manner, the instruction is generated by the instruction generating server 30 described later, the instruction of the designated file name is associated with use allowance information including information of the set access rights and the user information such as the user ID when the user is authenticated, and the same are saved in the folder. It should be noted that the cancel button 134 may be clicked when the user wishes to cancel the designation of the file destination.

In this manner, the created instruction is not limited to being saved within the device itself. It is also possible to save the created instruction in an external device connected to the network, such as the instruction managing server 40. When a file destination has not been designated, the created instruction may also be saved in a predetermined device, such as the instruction managing server 40.

Description will be given below of a case where the instruction is saved in the instruction managing server 40.

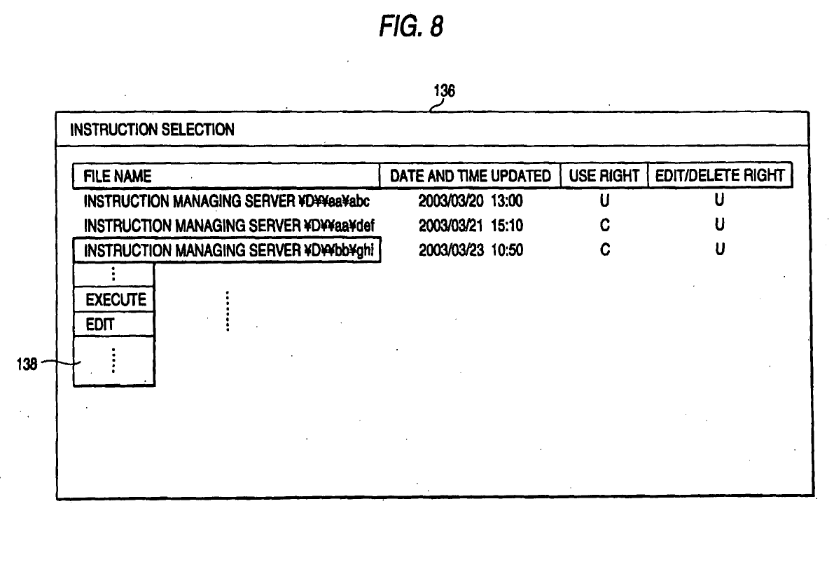

The instruction saved in the instruction managing server 40 or the like can be called up from the client terminal 10 and used. For example, in the instruction creation screen 100 of FIG. 4, when “File [F]”, which is a menu relating to file operations, is clicked, the pull-down menu 120 is displayed as shown in FIG. 9. When “Open” is clicked in the pulldown menu 120, an instruction selection screen 136 such as shown in FIG. 8 is displayed.

In the instruction selection screen 136, information such as file names of the instructions that the user can select, the updated date and time, and the use right and edit/delete right is displayed in a list Here, as an example, a “U” displayed in the columns of the use right and edit/delete right represents that use is restricted only to the user, and a “C” represents that use is restricted to all users.

When user authentication is conducted, only the information of instructions that the user can use is displayed. When user authentication is not conducted, only the information of instructions that all users can use is displayed. The information of instructions that only other users can use is not displayed. Thus, the instructions that the user himself/herself can use can be easily grasped, and a desired instruction can be easily selected.

When the user clicks the desired instruction from among these, a pull-down menu 138 is displayed as shown in FIG. 8. Here, when the user selects “Edit”, the job flow of the selected instruction is displayed on the instruction creation screen 100 and the user can edit the content thereof. When the user selects “Execute”, the selected instruction is executed.

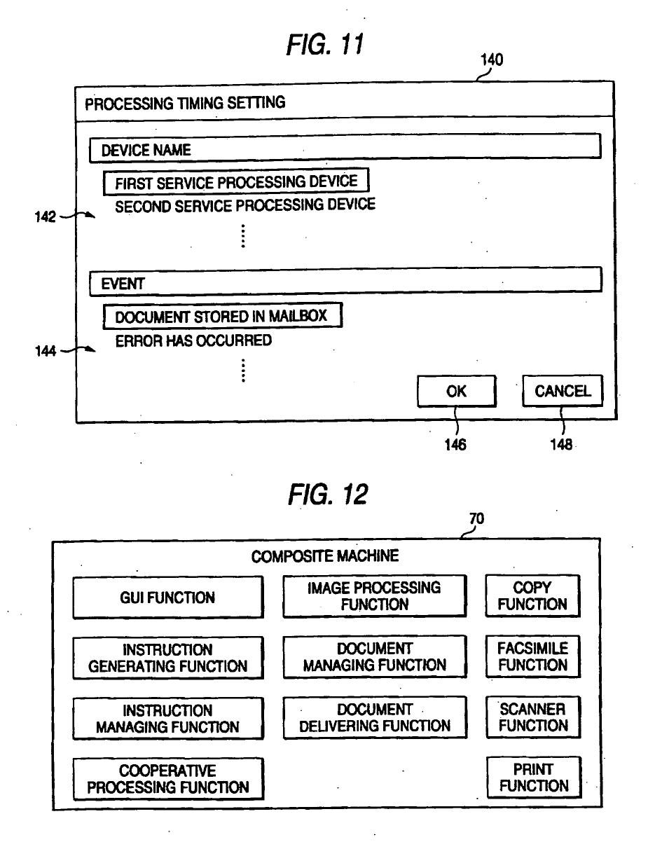

Also, the processing timing can be designated per instruction so that the instruction is automatically executed at a timing where a specific event occurs. For example, in the instruction creation screen 100 of FIG. 4, when “File [F]”, which is a menu relating to file operations, is clicked, the pull-down menu 120 is displayed as shown in FIG. 9. When “Processing Timing” is clicked in the pull-down menu 120, a processing timing setting screen 140 such as shown in FIG. 11 is displayed.

The processing timing setting screen 140 is configured by a device name display region 142 where the names of devices connected to the network 5 such as the first service processing device 64 are listed, an event display region 144 where a list of events occurring in the selected device is displayed, an OK button 146, and a cancel button 148.

When the device names are displayed on the screen, a list of types of events occurring in the device (in FIG. 11, the device enclosed by a frame) is displayed in the event display region 144. For example, in a case where the first service processing device 64 is a device disposed with a fax receiving function, when the first service processing device 64 is selected from the device names, a list of events having the potential to occur in that device, such as when a document is stored in the mailbox by facsimile reception or a transmission error has occurred during fax reception, is displayed in the event display region 144.

The information of the relations between the device names and the list of events is stored in advance in, for example, the service searching server 20. This information includes, in the I/F information that each device has, events having the potential to occur in the device, and is generated by the devices sending the I/F information to the service searching server 20. Thus, when the processing timing setting screen 140 is displayed, the information of the relations between the device names and the list of events is acquired from the service searching server 20 and, on the basis of this, the device names and the list of events can be displayed on the processing timing setting screen 140.

Here, when an event that the user wishes to set as a timing for executing the instruction is selected and the OK button 132 is clicked, processing timing information including the selected device name and event is temporarily stored in the client terminal 10. When the user wishes to cancel the selection, the user may click the cancel button 148.

When the user defines the job flow in the instruction creation screen 100 and designates the file destination, the client terminal 10 sends the job flow information defined by the operation of the user to the instruction generating server 30 in accordance with a CGI (Common Gateway Interface) format. When the file information relating to the file destination and file name of the instruction, the use allowance information and the processing timing are set, the processing timing information is also sent to the instruction generating server 30.

The instruction generating server 30 creates, on the basis of the I/F information of the services and the job flow information relating to an instruction of service cooperation from the user, an instruction where information for identifying the processing target document, such as the content of processing requested of the service, input parameters, manner of cooperation of the services (job flow), document name and storage location, is defined. The instruction is configured in the XML format.

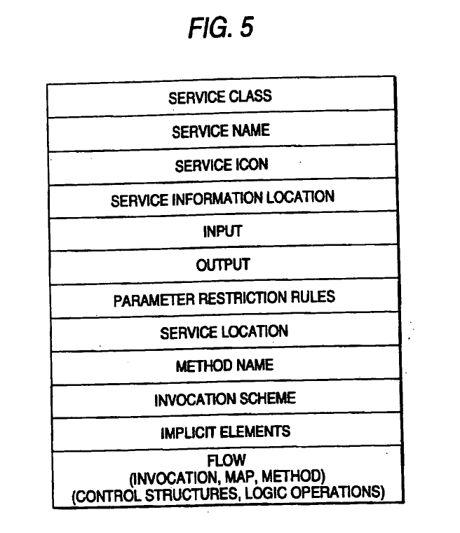

FIG. 5 is a conceptual diagram showing an instruction configured in XML format. Because the cooperative processing of plural services is also regarded as one service, the instruction has a configuration where “Flow” is added to the I/F information shown in FIG. 3.

“Flow” is an element that describes the cooperation between services, and includes elements such as “Invocation”, control structures, logic operations and “if” for determining conditions, operation instructions of an XML structure for adjusting the cooperation between services, and information for identifying the processing target document.

“Invocation” represents the specific method of the service processing device and executes the calling-up of the services. Included as “Invocation” elements are “Map”, which represents the position information of the parameters, and a method name “Method” that is called up. “if”, “and”, “eq” and “gt”, which represent control structures and logic operations, conduct condition branching at the time of cooperative processing and execute adjustment of the parameters sent between the services.

The instruction describes, in the “Flow” elements, all information relating to the control of the cooperative processing of the services. Thus, the cooperative processing itself, which is represented by the instruction, is regarded as one service. It should be noted that the instruction is not limited to the configuration shown in FIG. 5 and that it suffices as long as the instruction can effect cooperation of services.

When the instruction generating server 30 sends the use allowance information to the file destination together with the above instruction of the XML format and receives the processing timing information, it sends the file information to the instruction managing server 40 together with this. Thus, the instruction and the use allowance information are associated with each other and saved in the designated file destination. Also, when execution of service cooperation processing is designated by the user, the instruction generating server 30 may also send the instruction directly to the cooperative processing server 50.

When the instruction managing server 40 receives the file information and the processing timing information, it stores a correspondence relation in which the processing timing information and the file destination of the instruction are associated. Additionally, when the designated specific event occurs in the device designated by the processing timing information, the instruction managing server 40 requests the designated device to give notification of this. Also, when the instruction managing server 40 is designated as the file destination of the instruction and receives the instruction and the use allowance information, the instruction managing server 40 associates the instruction sent from the instruction generating server 30 with the use allowance information and stores the same.

When the instruction managing server 40 is requested by the client terminal 10 to execute an instruction, the instruction managing server 40 reads that instruction and sends it to the cooperative processing server 50. When the instruction managing server 40 is notified by another device that a specific event has occurred, the instruction managing server 40 identifies the file destination of the instruction corresponding to the notified event on the basis of the stored correspondence relation, reads the instruction of the file destination of that instruction, and sends it to the cooperative processing server 50.

The cooperative processing server 50 is a server that interprets/executes the designated instruction. When an instruction is sent from the instruction managing server 40, the cooperative processing server 50 interprets the instruction, calls up in order the service processing devices such as the image processing device 61, the document managing server 62 and the document delivering server 63 in accordance with the use method and order described in the instruction, and executes cooperative processing. Also, the cooperative processing server 50 saves the status of the cooperative processing during execution and the information of the result of the concluded cooperative processing, and provides notification of the status and result of the cooperative processing in response to a request from the outside.

When the cooperative processing server 50 interprets the instruction and requests the service processing devices, the cooperative processing server 50 generates separate instruction information including information for identifying the processing target document, the input parameters and the processing request content. It should be noted that the cooperative processing server 50 may also describe, in the instruction, the association between processing before and after the processing conducted by the service processing devices, or may be configured to request processing in information conversion formats unique to each service processing device and not the format of the instruction.

The image processing device 61 is a computer in which is installed a software program that conducts image processing functions. The image processing device 61 conducts document processing on the basis of the information of the processing target document, the input parameters and the service processing request content included in the processing request from the cooperative processing server 50. The image processing device 61 also notifies the service searching server 20 of the partial I/F information at the time of invocation. Moreover, the image processing device 61 sends the I/F information representing the use method of the image processing service in response to a request from the instruction generating server 30. This I/F information is used at the time the instruction is created.

The document managing server 62 includes a document storage function. The document managing server 62 executes storage, searching and reading of the document, changes attributes relating to the document and executes various processing on the basis of the information included in the request from the cooperative processing server 50. The document managing server 62 also notifies the service searching server 20 of the partial I/F information at the time of invocation. Moreover, the document managing server 62 sends the I/F information representing the use method of the document managing service in response to a request from the instruction generating server 30.

The document delivering server 63 is disposed with functions for storing the acquired document in the designated document managing server, sending e-mails and faxes to designated transmission destinations, and conducting print output processing to a designated printer. The document delivering server 63 conducts document delivery processing, on the basis of the document designated by the client terminal 10 and the information of the delivery destination thereof, in response to a rest from the cooperative processing server 50. The document delivering server 63 also notifies the service searching server 20 of the partial I/F information at the time of invocation. Moreover, the document delivering server 63 sends the I/F information representing the use method of the document delivery processing service in response to a request from the instruction generating server 30.

The first service processing device 64 is a device that conducts predetermined service processing relating to a document in accordance with an instruction from the outside. Here, the first service processing device 64 executes service processing that the first service processing device 64 itself is to execute on the basis of information such as information for identifying the processing target document, the input parameters and the processing request content from the cooperative processing server 50. The first service processing device 64 also notifies the service searching server 20 of the partial I/F information at the time of invocation. Moreover, the first service processing device 64 sends the I/F information representing the use method of the service processing in response to a request from the instruction generating server 30. It should be noted that the second service processing device 65 operates in the same manner as the first service processing device 64 with the exception of the content of the service processing.

In the document processing system 1 configured as described above, when application programs for executing predetermined services are installed, the service processing devices such as the image processing device 61, the document managing server 62 and the document delivering server 63 operate in the following manner.

During invocation processing, the service processing devices such as the image processing device 61, the document managing server 62 and the document delivering server 63 notify the service searching server 20 of the partial I/F information including information representing the addresses and the service outlines of each.

The service searching server 20 saves the partial I/F information sent from the service processing devices such as the image processing device 61, the document managing server 62 and the document delivering server 63. Thus, for example, when there is a predetermined service search request from the instruction generating server 30 or the cooperative processing server 50, the service searching server 20 can execute a search using the partial I/F information.

It should be noted that the cooperative processing server 50 corresponds to interpreting unit and cooperative processing unit of the invention, the client terminal 10 corresponds to setting unit of the invention, the instruction generating server 30 corresponds to generating unit of the invention, and the instruction managing server 40 corresponds to storing unit, identifying unit and authenticating unit of the invention.

(Creation of Instruction)

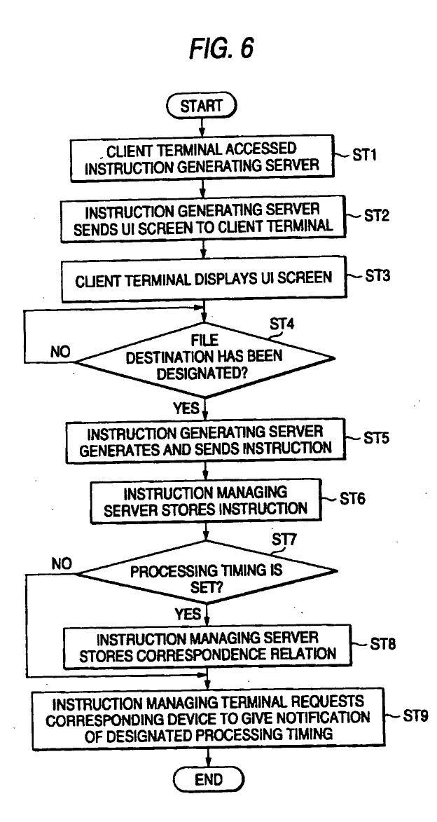

FIG. 6 is a flow chart showing the processing sequence of the client terminal 10, the instruction generating server 30 and the instruction managing server 40 at the time the instruction is created.

In accordance with the operation of the user, the client terminal 10 accesses, through an installed browser, the URL (Uniform Resource Locator) of the HTML file generated for a user interface screen that the instruction generating server 30 provides (step ST1).

The instruction generating server 30 sends, to the client terminal 10, the HTML file of the user interface screen in response to the browse request from the client terminal 10 (step ST2).

It should be noted that, prior to this processing, an HTML file of a user authentication screen may be sent to the client terminal 10 to conduct user authentication.

The client terminal 10 displays the user interface screen on the basis of information configuring the screen included in the HTML file sent from the instruction generating server 30 (step ST3). At this time, the user can use the user interface screen displayed on the client terminal 10 to define a job flow of desired service cooperation and to designate the file destination of the instruction, the setting of the access rights and the processing timing of the instruction.

The client terminal 10 determines whether or not the job flow has been defined and the file destination has been set via the user interface screen, and stands by until the file destination is set (step ST4). When the client terminal 10 determines that the file destination has been set, the client terminal 10 sends, to the instruction generating server 30, the job flow information relating to the service cooperation defined by the user, the file information relating to the file destination and the file name of the instruction, the use allowance information and the processing timing information.

The instruction generating server 30 creates, on the basis of the information relating to the job flow of the service cooperation sent from the client terminal 10 and the I/F information acquired from the service processing devices, an instruction in which are defined the content of the processing to be requested of the servers, the input parameters, the manner of cooperation of the services, and the information for identifying the processing target document such as the document name and the storage location information. Then, the instruction generating server 30 sends an XML-format instruction, the file information, the use allowance information and the processing timing information to the instruction managing server 40, which is the device of the designated file destination (step ST5).

In accordance with the file information, the instruction managing server 40 designated as the file destination associates the instruction generated by the instruction generating server 30 with the use allowance information and saves the same (step ST6). The instruction managing server 40 can save plural instructions created by the instruction generating server 30. When there is an instruction from the client terminal 10 to select an instruction, the instruction managing server 40 reads the selected instruction.

Also, the instruction managing server 40 determines whether or not it has received the processing timing information (step ST7). When it has received the processing timing information, the instruction managing server 40 stores the correspondence relation in which the processing timing information and the file destination of the instruction are associated (step ST8).

Then, when the specific event designated by the processing timing information occurs, the instruction managing server 40 requests the device designated by the processing timing information to give notification thereof (step ST9). Thus, when the device requested to give notification detects that the designated specific event has occurred, the device notifies the instruction managing server 40 thereof.

(Invocation/Execution of Cooperative Processing)

The user can invoke cooperative processing by selecting a desired instruction from among the plural instructions saved in the instruction managing server 40, and can invoke cooperative processing at a timing at which the specific event occurs. Here, the first service processing device 64 is disposed with a fax receiving function and is capable of communicating through a mailbox. Description will be given of a case where the instruction is executed at a timing at which a document is stored in the mailbox.

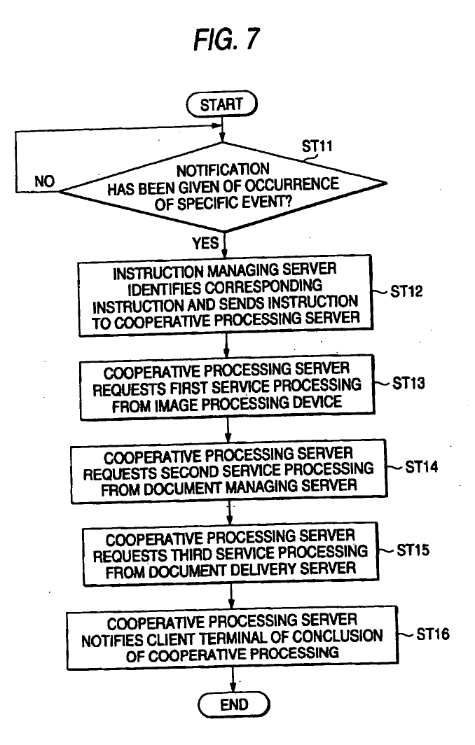

FIG. 7 is a flow chart showing the processing of the instruction managing server 40 and the cooperative processing server 50. Here, description will be given of a case where image processing such as noise removal and OCR processing is conducted on a document stored in the mailbox of the fist service processing device 64, processing for binding an extracted test document and an extracted image document is conducted, the bound documents are stored in a predetermined storage destination, only the text document of the bound documents is sent to an e-mail address that is designated as a transmission destination, and an instruction is executed where processing to fax only the image document to a designated fax number is instructed.

The instruction managing server 40 determines whether or not notification has been given from a device connected to the network 5 that a specific event has occurred (step ST11).

When notification has not been given that a specific event has occurred, the instruction managing server 40 stands by until notification is given. Here, when a document is stored in the mailbox of the first service processing device 64, the first service processing device 64 notifies the instruction managing server 40 that the document has been stored in the mailbox.

When the instruction managing server 40 has been notified that the specific event has occurred, the instruction managing server 40 identifies the instruction corresponding to the specific notified event on the basis of the prestored correspondence relation in which the processing timing information and the file destination of the instruction are associated, reads the instruction, and sends the instruction to the cooperative processing server 50 (step ST12). As a result, the cooperative processing server 50 initiates execution of cooperative processing.

The cooperative processing server 50 interprets the instruction sent from the instruction managing server 40 and requests the image processing device 61, which is the first processing described in the instruction, to execute first service processing (step ST13). Specifically, the cooperative processing server 50 extracts, on the basis of the information described in the instruction, the information identifying the input parameter and output parameter formats necessary for the processing request and the location of the service processing device with respect to which processing is requested, the method name for the processing request, the invocation scheme, and the processing target document (here, the document stored in the mailbox of the first service processing device 64), and creates separate instruction information. The cooperative processing server 50 sends the separate instruction information to the image processing device 61, which is the first processing request destination.

The image processing device 61 copies the processing target document on the basis of the storage destination location information of the processing target document described in the sent instruction, and acquires the document. With respect to the acquired image document, the image processing device 61 interprets the service processing request content, conducts image processing such as noise removal and OCR processing, and conducts processing to bind the image document with the extracted text document. The image processing device 61 restores, in the original storage destination, a document where the image document obtained by the image processing and the text document are bound. When this processing concludes, the image processing device 61 sends, to the cooperative processing server 50, the processing results, such as status information of the processing (concluded), output parameters, and post-processing document storage destination information.

When the cooperative processing server 50 receives the processing results from the image processing device 61, the cooperative processing server 50 manages the result of the first processing request as a log. Then, the cooperative processing server 50 identifies a second processing request destination on the basis of the instruction and requests the document managing server 62 to execute second service processing (step ST14). Similar to the first service processing request, the cooperative processing server 50 sends separate instruction information (information for storing the document, which is information relating to the processing request, information of the storage destination of the document; and information identifying the processing target document) to the document managing server 62.

On the basis of the storage destination information described in the request content, the document managing server 62 conducts storage processing of the document processed and stored in the previous processing (first service processing) on the basis of the request content of the cooperative processing server 50. When this processing is concluded, the document managing server 62 sends, to the cooperative processing server 50, the processing results, such as status information of the processing (concluded), output parameters, and post-processing document storage destination information.

When the cooperative processing server 50 receives the processing results from the second service processing (document storage processing), the cooperative processing server 50 manages the result of the second processing request as a log. The cooperative processing server 50 identifies a third processing request destination on the basis of the instruction and requests the document delivering server 63 to execute third service processing (step ST15). Similar to the second service processing request, the cooperative processing server 50 sends separate instruction information (information for storing the document, which is information relating to the processing request; information of the storage destination of the document; and information identifying the processing target document) to the document delivering server 63.

On the basis of the information (storage destination information) identifying the document, the document delivering server 63 reads the document file of the document processed and stored in the previous processing (second service processing) on the basis of the request content of the cooperative processing server 50, and conducts the processing described in the request content. Here, the document delivering server 63 e-mails, to an e-mail address that is designated as the transmission destination, only the text document of the document in which the text document and the image document are bound, and faxes only the image document to a designated fax number. When this processing is concluded, the document delivering server 63 sends, to the cooperative processing server 50, the processing results, such as status information of the processing (concluded), output parameters, and post-processing document storage destination information.

In this processing, for example, in fax transmission processing, when the line to which the fax is to be sent is busy and a connection cannot be established even after retrying a predetermined number of times, the document delivering server 63 sends “e-mail transmission: completed; fax transmission: not sent” to the cooperative processing server 50 as status information.

When the cooperative processing server 50 receives the processing result from the third service processing and determines that subsequent processing is not described in the instruction, the cooperative processing server 50 notifies the client terminal 10 that all processing has been completed and concludes the cooperative processing (step ST16).

In this manner, in the present embodiment, because the instruction is automatically executed at the timing at which the document is stored in the mailbox of the first service processing device 64, it is not necessary for the user himself/herself to confirm whether or not the document has been stored in the mailbox and to instruct execution of the instruction, and various and complicated processing can be rapidly and easily conducted.

Although description was given in the present embodiment of a case where an instruction instructing that OCR processing and the like be executed at a timing at which a document is stored in the mailbox of the first service processing device 64 is automatically executed, the specific event and the content of processing executed by the instruction are not limited thereto.

For example, the fact that an error has occurred during execution of a job can be used as the specific event, and the processing timing can be set so that an instruction instructing the fact that an error has occurred and the content of the error be printed out when that event occurs is executed Thus, when the job has concluded with an error, a report of the content of the error can be automatically outputted. Also, when user authentication is conducted, the instruction can be designated per user.

Also, the fact that an error has occurred within a device can be used as the specific event, and the processing timing can be set so that an instruction instructing that the content of the error be printed out when that event occurs is executed. Thus, when an error has occurred within a device, for example, when a device has run out of toner, a message representing this can be automatically outputted.

Also, the fact that a predetermined job has been concluded a predetermined number of times can be used as the specific event, and the processing timing can be set so that an instruction instructing that the processing history of the job be printed out when that event occurs is executed. Thus, when a predetermined job such as fax transmission processing has been conducted a predetermined number of times, the transmission history can be automatically outputted.

Also, the fact that it has become a predetermined time can be used as the specific event, and the processing timing can be set so that an instruction instructing execution of a job when that event occurs is executed. Thus, for example, print processing can be automatically conducted at night, and a job such as conducting data transfer processing can be executed.

Also, the fact that user authentication has been conducted can be used as the specific event, and the processing timing can be set so that an instruction instructing that processing for changing the operation screen to the user environment when that event occurs is executed. Thus, when user authentication has been conducted, separate operation screens can be displayed per user and the execution environment of the job can be changed per user.

Also, although a case was described in the present embodiment where the correspondence relation between the processing timing information and the file destination of the instruction was stored in the instruction managing server 40, the invention is not limited thereto and may be configured so that the processing timing information is described in the instruction.

Also, each of the servers connected to the network 5 and described in the above embodiment may be configured as an independent device, several may be put together and disposed within a single device, or all may be disposed within a single device.

For example, as shown in FIG. 12, the invention may be configured so that the GUI function of the client terminal 10 for conducting various operations such as creating the instruction and selecting the instruction, the instruction generating function of the instruction generating server 30, the instruction managing function of the instruction managing server 40, the cooperative processing function of the cooperative processing server 50, the image processing function of the image processing device 61, the document managing function of the document managing server 62 and the document delivering function of the document delivering server 63 are disposed in a composite machine 70 disposed with the respective functions of a copy function, a fax function, a scanner function and a print function as functions for conducting service processing.

In this case, the instruction can be created and saved in the composite machine 70, and image processing such as noise removal processing and OCR processing, post-processing storage processing of document data, fax transmission and e-mail transmission can be cooperatively effected on document data stored in the composite machine 70. Of course, similar to the above-described embodiment, it is also possible for the client terminal 10 to create or select an instruction.

Also, the processing target document data and instruction may also be stored in another external device connected to the network 5. Also, rather than the composite machine 70 processing the document data saved in the composite machine 70 or the document data stored in another external device, another external composite machine connected to the network or other external devices including respective processing functions and each connected to the network may conduct processing.

Also, although the service searching server 20 acquires part of the I/F information partial I/F information) from the service processing devices in the present embodiment, the server searching server 20 may also be configured to acquire all of the I/F information.

### Second Embodiment

Next, a second embodiment of the invention will be described. It should be noted that the same reference numerals will be given to sections that are the same as those of the first embodiment, and that detailed description of those sections will be omitted.

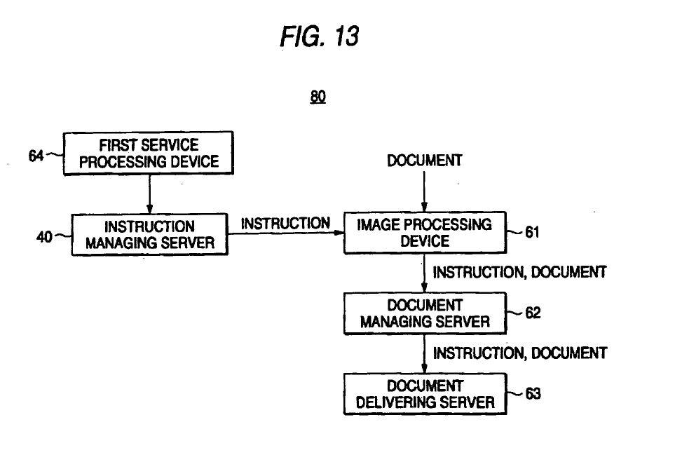

FIG. 13 is a block diagram for describing the interrelation of service processing devices configuring a document processing system 80 pertaining to the second embodiment. The document processing system 80 pertaining to the second embodiment executes cooperative processing of plural services without using the cooperative processing server 50 shown in FIGS. 1 and 2.

It should be noted that, although the document processing system 80 is disposed with the service processing devices shown in FIG. 1 (excluding the cooperative processing server 50), only the service processing devices relating to cooperative processing are shown in FIG. 13.

(Invocation/Execution of Cooperative Processing)

Similar to the first embodiment, the user can automatically invoke cooperative processing by designating an instruction that is to be executed when a specific event occurs. A case will be described below where, similar to the first embodiment, the first service processing device 64 is disposed with a fax receiving function and is capable of communicating through a mailbox., and the instruction is executed at a timing at which a document is stored in the mailbox.

When the instruction managing server 40 has been notified by a device connected to the network 5 that a specific event has occurred, i.e., when the instruction managing server 40 has been notified by the first service processing device 64 that a document has been stored in the mailbox of the first processing device 64, the instruction managing server 40 identifies, on the basis of the prestored correspondence relation in which the processing timing information and the file destination of the instruction are associated, the instruction corresponding to the notified specific event, reads the instruction, and sends the instruction to the image processing device 61.

The image processing device 61 acquires the processing target document on the basis of the storage destination location information of the processing target document (here, the document stored in the mailbox of the first service processing device 64) described in the sent instruction. With respect to the acquired image document, the image processing device 61 interprets the service processing request content, conducts image processing such as noise removal and OCR processing, and conducts processing to bind the image document with the extracted text document After the predetermined image processing is concluded, the image processing device 61 deletes the service processing request described in the instruction. Then, the image processing device 61 sends, to the document managing server 62 providing the next service processing, a document in which the text document and the image document obtained by image processing are bound and the instruction including the processing result such as the status information of the processing (concluded), the output parameters and the post-processing document storage destination information

The image processing device 61 may also be configured so that, after the predetermined image processing is concluded, the image processing device 61 revises or deletes the portion relating to its own service request described in the instruction and sends it to the document managing server 62. Moreover, the image processing device 61 may also be configured so that, after the predetermined image processing is concluded, the image processing device 61 sends the instruction to the next service processing device.

The document managing server 62 temporarily stores the document sent from the image processing device 61 in the storage destination described in the instruction. Then, the document managing server 62 deletes the service processing request described in the instruction and sends the document and the instruction to the document delivering server 63, which conducts the next service processing.

On the basis of the instruction, the document delivering server 63 e-mails only the text document of the document in which the text document and the image document are bound to an e-mail address designated as the delivery destination, and faxes only the image document to a designated fax number. Then, when the document delivering server 63 determines that subsequent processing is not described in the instruction, the document delivering server 63 notifies the client terminal 10 that all processing has been completed, and concludes the cooperative processing.

It should be noted that, in the present embodiment, similar to the first embodiment, each of the devices connected to the network 5 such as the servers may be configured as an independent device, several of the devices may be put together and disposed within a single device, or all of the devices may be disposed within a single device.

According to the present invention, there is the effect that the invention can cause devices connected to a network to cooperatively effect plural processes to be executed on document data.

The entire disclosure of Japanese Patent Application No. 2003-079270 filed on Mar. 24, 2003 including specification, claims, drawings and abstract is incorporated herein by reference in its entirety.

What is claimed is:

1. A service processing apparatus comprising:
a storing unit in which are stored (a) instruction data in which are described at least a location of processing document data and a content of plural service processes to be executed on the document data and (b) a correspondence relation between instruction data that is to be processed when a specific event occurs and the specific event;
an identifying unit that identifies, when notification that the specific event has occurred is given by at least one of plural service processing apparatuses each connected to a network, instruction data corresponding to the notified specific event on the basis of the correspondence relation;
an interpreting unit that interprets the content of the identified instruction data; and
a cooperative processing unit that makes the plural service processing apparatuses cooperatively execute the plural service processes on the document data on the basis of the interpretation result of the interpreting unit.

2. The service processing apparatus of claim 1, further comprising:
a setting unit that sets the instruction data and the content of the specific event serving as a processing timing of the instruction data; and
a generating unit that generates, on the basis of the setting content set by the setting unit, the correspondence relation and instruction data for executing the plural service processes on the document data, and stores the correspondence relation and the instruction data in the storing unit.

3. The service processing apparatus of claim 2, further comprising an authenticating unit that authenticates a creator of the instruction data, wherein the generating unit associates information of the creator of the instruction data with the instruction data and stores the creator information and the instruction data in the storing unit.

4. A service processing method comprising:
identifying, when notification that a specific event has occurred is given by at least one of plural service processing apparatuses each connected to a network, instruction data that corresponds to the notified specific event and in which are described at least a location of processing document data and a content of plural service processes to be executed on the document data, on the basis of a correspondence relation between the specific event and instruction data that is to be processed when the specific event occurs;
interpreting the content of the identified instruction data; and
making the plural service processing apparatuses cooperatively execute the plural service processes on the document data on the basis of the interpretation result of the interpreting step.

5. The service processing method of claim 4, further comprising:
setting the instruction data and the content of the specific event serving as a processing timing of the instruction data; and
generating, on the basis of the content set by the setting step, the correspondence relation and instruction data for executing the plural service processes on the document data, and storing the correspondence relation and the instruction data in a storing unit.

6. The service processing method of claim 5, further comprising authenticating a creator of the instruction data, wherein information of the creator of the instruction data is associated with the instruction data, and the creator information and the instruction data are stored in the storing unit in the generating step.

7. A service processing apparatus comprising:
a storing unit in which are stored (a) instruction data in which are described at least a location of processing document data and a content of plural service processes to be executed on the document data and (b) a correspondence relation between instruction data that is to be processed when a specific event occurs and the specific event;
an identifying unit that identifies, when notification that the specific event has occurred is given by at least one of plural service processing apparatuses each connected to a network, instruction data corresponding to the notified specific event on the basis of the correspondence relation; and
a sending unit that sends the instruction, data identified by the identifying unit to a cooperative processing apparatus that cooperatively executes the plural service processes on the document data.

8. The service processing apparatus of claim 7, further comprising:
a setting unit that sets the instruction data and the content of the specific event serving as a processing timing of the instruction data; and
a generating unit that generates, on the basis of the content set by the setting unit, the correspondence relation and instruction data for executing the plural service processes on the document data, and stores the correspondence relation and the instruction data in the storing unit.

9. The service processing apparatus of claim 8, further comprising an authenticating unit that authenticates a creator of the instruction data, wherein the generating unit associates information of the creator of the instruction data with the instruction data and stores the creator information and the instruction data in the storing unit.

10. A service processing method comprising:
identifying, when notification that a specific event has occurred is given by at least one of plural service processing apparatuses each connected to a network, instruction data that corresponds to the notified specific event and in which are described at least a location of processing document data and a content of plural service processes to be executed on the document data, on the basis of a correspondence relation between the specific event and instruction data that is to be processed when the specific event occurs;
sending the identified instruction data to a cooperative processing apparatus that cooperatively executes the plural service processes on the document data.

11. The service processing method of claim 10, further comprising:
setting the instruction data and the content of the specific event serving as a processing timing of the instruction data; and
generating, on the basis of the content set by the setting step, the correspondence relation and instruction data for executing the plural service processes on the document data, and storing the correspondence relation and the instruction data in a storing unit.

12. The service processing method of claim 11, further comprising authenticating a creator of the instruction data, wherein information of the creator of the instruction data is associated with the instruction data and the creator information and the instruction data are stored in the storing unit in the generating step.

13. A service processing apparatus comprising:
a storing unit in which are stored (a) instruction data in which are described at least a location of processing document data and a content of plural service processes to be executed on the document data and (b) a correspondence relation between instruction data that is to be processed when a specific event occurs and the specific event;
an identifying unit that identifies, when notification that the specific event has occurred is given by at least one of plural service processing apparatuses each connected to a network, instruction data corresponding to the notified specific event on the basis of the correspondence relation; and
a sending unit that sends the instruction data identified by the identifying unit to another service processing apparatus that conducts a service process on the document data described in the instruction data.

14. The service processing apparatus of claim 13, further comprising:
a setting unit that sets the instruction data and the content of the specific event serving as a processing timing of the instruction data; and
a generating unit that generates, on the basis of the content set by the setting unit, the correspondence relation and instruction data for executing the plural service processes on the document data, and stores the correspondence relation and the instruction data in the storing unit.

15. The service processing apparatus of claim 14, further comprising an authenticating unit that authenticates a creator of the instruction data, wherein the generating unit associates information of the creator of the instruction data with the instruction data and stores the creator information and the instruction data in the storing unit.

16. A service processing method comprising:
identifying, when notification that a specific event has occurred is given by at least one of plural service processing apparatuses each connected to a network, instruction data that corresponds to the notified specific event and in which are described at least a location of processing document data and a content of plural service processes to be executed on the document data, on the basis of a correspondence relation between the specific event and instruction data that is to be processed when the specific event occurs; and
sending the identified instruction data to another service processing apparatus that conducts a service process on the document data described in the instruction data.

17. The service processing method of claim 16, further comprising:
setting the instruction data and the content of the specific event serving as a processing timing of the instruction data; and
generating, on the basis of the content set by the setting step, the correspondence relation and instruction data for executing the plural service processes on the document data, and storing the correspondence relation and the instruction data in storing unit.

18. The service processing method of claim 17, further comprising authenticating a creator of the instruction data, wherein information of the creator of the instruction data is associated with the instruction data and the creator information and the instruction data are stored in the storing unit by the generating step.

19. The service processing apparatus of claim 1, wherein the specific event is reception of document data from the outside.

20. The service processing apparatus of claim 1, wherein the specific event is arrival of a predetermined time.
